(19) United States
(12) Patent Application Publication
(10) Pub. No.: US 2012/0323967 A1
(43) Pub. Date: Dec. 20, 2012

(54) Spelling Using a Fuzzy Pattern Search

(75) Inventors: Yun-Cheng Ju, Bellevue, WA (US); Ivan J. Tashev, Kirkland, WA (US); Xiao Li, Bellevue, WA (US); Dax Hawkins, Kirkland, WA (US); Thomas Soemo, Redmond, WA (US); Michael H. Kim, Redmond, WA (US)

(73) Assignee: MICROSOFT CORPORATION, Redmond, WA (US)

(21) Appl. No.: 13/159,442

(22) Filed: Jun. 14, 2011

(51) Int. Cl. G06F 17/30

(52) U.S. Cl. 707/780; 707/E17.014

(57) ABSTRACT

A multimedia system configured to receive user input in the form of a spelled character sequence is provided. In one implementation, a spell mode is initiated, and a user spells a character sequence. The multimedia system performs spelling recognition and recognizes a sequence of character representations having a possible ambiguity resulting from any user and/or system errors. The sequence of character representations with the possible ambiguity yields multiple search keys. The multimedia system performs a fuzzy pattern search by scoring each target item from a finite dataset of target items based on the multiple search keys. One or more relevant items are ranked and presented to the user for selection, each relevant item being a target item that exceeds a relevancy threshold. The user selects the indented character sequence from the one or more relevant items.

### BACKGROUND

Many modern multimedia environments have limited user input sources and display modalities. For example, many game consoles do not include keyboards or other devices for easily entering data. Further, having limited user input sources and user interfaces in modern multimedia environments presents a challenge to a user seeking to search through and select from a large finite set of data entries.

Speech recognition enables a user to interface with a multimedia environment. However, there exist a growing number of contexts in multimedia environments where data entered through conventional speech recognition technologies results in errors. For example, there are many contexts where a user does not pronounce a word correctly or the user is unsure of how to pronounce a character sequence. In such contexts, it could be effective for the user to spell the character sequence. However, it is a challenge for multimedia environments and other speech recognition interfaces to recognize a spelled character sequence correctly. Conventional speech recognition interfaces (e.g., using context free grammar) may not effectively accommodate any user mistakes. Further, many characters sound similar (e.g., the E-set letters including B, C, D, E, G, P, T, V, and Z) resulting in misrecognition errors by the speech recognition interface. Accordingly, multimedia environments lack an effective user interface enabling a user to input a spelled character sequence to retrieve data from a large fixed database.

### SUMMARY

Implementations described and claimed herein address the foregoing problems by providing a multimedia system configured to receive user input in the form of a spelled character sequence, which may be spoken or handwritten. In one implementation, a spell mode is initiated in a multimedia system, and a user spells a character sequence. The spelled character sequence may contain user errors and/or system errors. User errors include without limitation misspellings, omitted characters, added characters, or mispronunciations, and system errors include without limitation speech or handwriting recognition errors. The multimedia system performs spelling recognition and recognizes a sequence of character representations having a possible ambiguity resulting from any user or system errors. The sequence of character representations with the possible ambiguity yields multiple search keys. The multimedia system performs a fuzzy pattern search by scoring one or more target items from a finite dataset of target items based on the multiple search keys. One or more relevant items are ranked and presented to the user for selection, each relevant item being a target item that exceeds a relevancy threshold. The user selects the spelled character sequence from the one or more relevant items.

In some implementations, articles of manufacture are provided as computer program products. One implementation of a computer program product provides a tangible computer program storage medium readable by a computing system and encoding a processor-executable program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example implementation of a multimedia environment using voice search.

FIG. 2 illustrates an example implementation of a dictation system using fuzzy pattern searching.

FIG. 3 illustrates an example implementation of a spelling system using fuzzy pattern searching.

FIG. 4 illustrates an example implementation of six example listing database sources.

FIG. 5 illustrates example operations for spelling using a fuzzy pattern search.

FIG. 6 illustrates an example implementation of a capture device that may be used in a spelling recognition, search, and analysis system.

FIG. 7 illustrates an example implementation of a computing environment that may be used to interpret one or more character sequences in a spelling recognition, search, and analysis system.

FIG. 8 illustrates an example system that may be useful in implementing the technology described herein.

### DETAILED DESCRIPTION

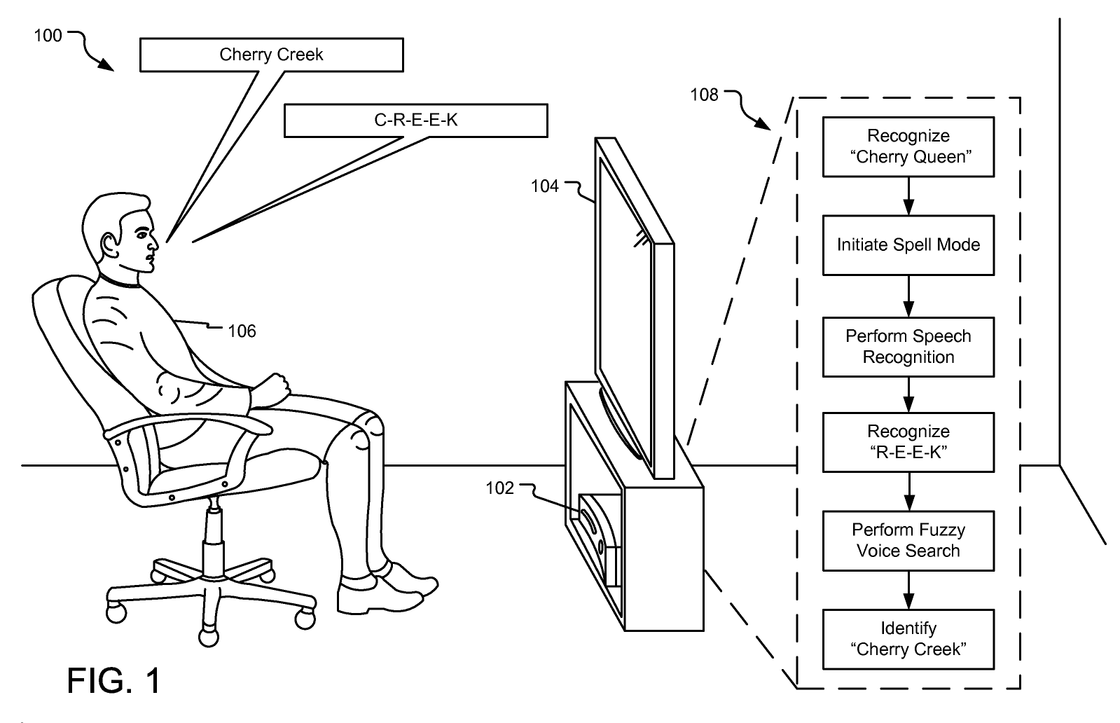

FIG. 1 illustrates an example implementation of a multimedia environment 100 using voice search. The multimedia environment 100 extends from a multimedia system 102 by virtue of a user interface 104, which may include a graphical display, a touch-sensitive display, scanner, microphone, and/or audio system. The multimedia system 102 may be without limitation a gaming console, a mobile phone, a navigation system, a computer system, a set-top box, an automobile control system, or any other device capable of retrieving data in response to verbal, handwritten, or other input from a user 106.

To capture speech by the user 106, the user interface 104 and/or the multimedia system 102 includes a microphone or microphone array, which enables the user 106 to provide verbal input in the form of one or more sequences of characters, including words, phonemes, or phonetic fragments. Additionally, the user interface 104 and/or the multimedia system 102 may be configured to receive handwriting as a form of input from the user 106. For example, the user 106 may use a stylus to write a sequence of characters on a touch-sensitive display of the user interface 104, may employ a scanner to input documents with a handwritten sequence of characters, or may utilize a camera to capture images of a handwritten sequence of characters. Further, the multimedia system 102 may employ a virtual keyboard displayed via the user interface 104, which enables the user 106 to input one or more sequences of characters using, for example, a controller. The sequence of characters may include without limitation alphanumeric characters (e.g., letters A through Z and numbers 0 through 9), punctuation characters, control characters (e.g., a line-feed character), mathematical characters, sub-sequences of characters (e.g., words and terms), and other symbols. In one implementation, the sequences of characters may correspond to spelled instances of search terms, words, or other data entries.

The multimedia system 102 is configured to recognize, analyze, and respond to verbal or other input from the user 106, for example, by performing example operations 108 as illustrated in a dashed box in FIG. 1. In an example implementation, the user 106 provides verbal input to the multimedia system 102 by uttering the words “Cherry Creek.” The words may refer to a gamer tag, email, contact, social network, text, search term, application command, location, object, or other data entry. The multimedia system 102 receives the verbal input and performs speech recognition by converting the verbal input of the user 106 into query form (i.e. text) using an automated speech recognition (ASR) component, which may utilize an acoustic model. In one implementation, the ASR component is customized to the speech characteristics of one or more particular users.

The ASR component may use, for example, a statistical language model (SLM), such as an n-gram model, which permits flexibility in the form of user input. For example, the user 106 may not pronounce the words or character sequences correctly. Additionally, the user 106 may omit one or more characters or words. In one implementation, the SLM is trained based on a listing database that contains a fixed dataset including but not limited to a dictionary, social network information, text message(s), game information (e.g., gamer tags), application information, email(s), and contact list(s). The dictionary may include commonly misspelled character sequences, user added character sequences, commonly used character sequences or acronyms (e.g., OMG, LOL, BTW, TTYL, etc.), or other words or character sequences. Further, the listing database may include localized data including without limitation information corresponding to different regions, countries, or languages.

The ASR component returns one or more decoded speech recognition hypotheses, each including a sequence of character representations, which are the character(s) or word(s) that the ASR component recognizes as user input. The speech recognition hypotheses may be, for example, a set of n-best probabilistic recognitions of the input sequence of characters or words. The n-best probabilistic recognitions may be limited by fixing n according to a minimum threshold of probability or confidence, which is associated with each of the n-best probabilistic recognitions. The hypotheses are used to identify one or more probabilistic matches from the listing database.

In one implementation, the multimedia system 102 selects one or more sequences of character representations from the one or more probabilistic matches to present to the user 106. For example, the multimedia system 102 may select the probabilistic match with the highest confidence score. In the example implementation illustrated in FIG. 1, the multimedia system 102 recognized the words spoken by the user 106 as “Cherry Queen.” The multimedia system 102 presents the selected sequence of character representations (e.g., “Cherry Queen”) to the user 106 via the user interface 104.

Spell mode may be initiated to perform a correction pass. In one implementation, the user 106 initiates spell mode through a command including without limitation speaking a command (e.g. uttering “spell”), making a gesture, pressing a button, and selecting the misrecognized sequence of character representations (e.g., “Queen”). In another implementation, the user 106 initiates spell mode by verbally spelling or handwriting the corrected sequence of characters (e.g., “Creek”). Additionally, the user 106 may initiate spell mode by inputting the corrected sequence of characters via a virtual keyboard. In still another implementation, the multimedia system 102 prompts the user 106 to initiate spell mode, for example, in response to feedback from the user 106 or an internal processor that one or more of the sequences of character representations contain errors.

In the example implementation illustrated in FIG. 1, the user 106 utters spelling input in the form of the character sequence “C-R-E-E-K” that the multimedia system 102 misrecognized as “Queen.” The multimedia system 102 receives the spelling input and performs speech recognition. In one implementation, the multimedia system 102 identifies the sequence of character representations the spelling input is provided to correct (e.g., the spelling input “C-R-E-E-K” is provided to correct the sequence of character representations “Queen”). In another implementation, the user 106 selects the misrecognized word the spelling input is provided to correct. The spelled character sequence may contain user errors and/or system errors. User errors include without limitation misspellings, omitted characters, added characters, or mispronunciations, and system errors include without limitation speech or handwriting recognition errors. For example, the user 106 may omit characters, misspell a character sequence, and/or the multimedia system 102 may misrecognize the characters in the spelling input. Further, phonetically confusing letters (e.g., B, P, V, D, E, T, and C) may be merged into a reduced character set to improve overall speech recognition accuracy.

The speech recognition results in one or more decoded speech spelling recognition hypotheses, which are the character(s) recognized as user input. The speech recognition hypotheses may be, for example, a set of n-best probabilistic recognitions of the spelling input sequence of characters. The n-best probabilistic recognitions may be limited by fixing n according to a minimum threshold of probability or confidence, which is associated with each of the n-best probabilistic recognitions. The hypotheses are used to identify one or more probabilistic matches from the listing database. From the probabilistic matches, a sequence of spelling input character representations is recognized. The sequence of spelling character representations may have a possible ambiguity. The ambiguity may be based on user and/or system errors including without limitation commonly misspelled character sequences, similarity in character sound, character substitutions, character omissions, character additions, alternative possible spellings. In the example implementation illustrated in FIG. 1, the multimedia system 102 recognized the sequence of spelling character representations as “R-E-E-K” with ambiguity. The ambiguity in the sequence of spelling character representations yields multiple search keys, each search key including a character sequence.

To address the possible ambiguities, the multimedia system 102 performs a fuzzy voice search to identify one or more probabilistic matches that exceed a relevancy threshold. In one implementation, the fuzzy voice search is dynamic such that the fuzzy voice search is done in real-time as the user 106 utters each character. In another implementation, the fuzzy voice search commences after the user 106 has uttered all the characters in the spelling input.

The fuzzy voice search compares the multiple search keys to a finite dataset of target items contained in a search table, which is populated based on the listing database. Data for the listing database includes but is not limited to a dictionary, social network information, text message(s), game information, such as gamer tag(s), application information, email(s), and contact list(s). Further, the listing database may include localized data including without limitation information corresponding to different regions, countries, or languages. Each target item includes a character sequence. In one implementation, each target item further includes a set of sub-sequences of characters. The set of sub-sequences of characters includes sub-sequences with multiple adjacent characters, including bigrams and trigrams. Each sub-sequence of characters begins at a different character position of the target item.

The multiple search keys are generated from the sequence of spelling character representations. The possible character sequences may include multiple adjacent characters, including bigrams and trigrams. The fuzzy voice search may further remove one or more characters from the multiple search keys. In one implementation, non-alphanumeric characters such as punctuation characters or word boundaries are removed from the multiple search keys. In one implementation, phonetically confusing characters (e.g., B, P, V, D, E, T, and C) may be merged into a reduced search character set to account for possible speech misrecognitions. The reduced search character set permits the speech recognition to be performed without separating phonetically confusing character groups. In one implementation, a character from a reduced search character set is replaced with another character from the set, and the recognition of the character is relaxed to further include the pronunciation of another character in the set. For example, generally the letter “B” and the letter “V” may not be reliably distinguished. To merge the confusing characters into a reduced search character set, “V's” are replaced with “B's” and the expected pronunciation of “V” is relaxed to include the pronunciation of “V” as well. Accordingly, the multiple search keys may be generated based on phoneme similarity, which represents a similarity in sound units associated with uttered characters. Alternatively, in the handwriting implementation, graphically confusing letters may be merged into a reduced search character set to account for possible pattern misrecognitions. The multiple search keys may be generated based on character or glyph similarity, which represents the similarity in appearance associated with written characters.

The multimedia system performs the fuzzy voice search by scoring each target item based on the multiple search keys. In one implementation, each target item is scored based on whether the target item matches at least one of the multiple search keys. Target items are scored and ranked according to increasing relevance, which correlates to the resemblance of each target item to the sequence of spelling character representations. For example, the relevance value for a target item is higher where a fixed-length search key occurs in any position range in the target item or where a fixed-length search key starts at the same initial character position as the target item. Additionally, contextual information that may be particular to the user 106 is utilized to score and rank the target items.

Additionally, a ranking algorithm may be employed to further score and rank the target items based on the prevalence of a search key in the search table. For example, a term frequency-inverse document frequency (TF-IDF) ranking algorithm may be used, which increases the score of a target item based on the frequency that a search key occurs in the target item and decreases the score based on the frequency that the search key occurs in all target items in the search table database.

Based on the scores of the target items, one or more relevant items that satisfy a relevancy threshold are identified. In one implementation, one relevant item is identified and presented to the user 106. In another implementation, two or more relevant items are identified and presented to the user 106 via the user interface 104 for selection. The relevant items may be presented on the user interface 104 according to the score of each relevant item. The user 106 may select the intended character sequence from the presented relevant items, for example, through a user command including without limitation speaking a command, making a gesture, pressing a button, writing a command, and using a selector tool.

In the example implementation illustrated in FIG. 1, multiple search keys for the sequence of spelling character representations “R-E-E-K” are generated and compared to target items. Based on the scores of the target items, “Creek” is identified as a relevant item. In one implementation, the multimedia system 102 identifies “Creek” as a substitute character sequence for “Queen” a presents “Cherry Creek” to the user 106. In another implementation, the multimedia system 102 identifies “Creek” as a possible substitute character sequence for “Queen” and presents “Cherry Creek” among a set of possible substitute character sequences via the user interface 104. The user 106 may select “Cherry Creek” from the set of possible substitute character sequences.

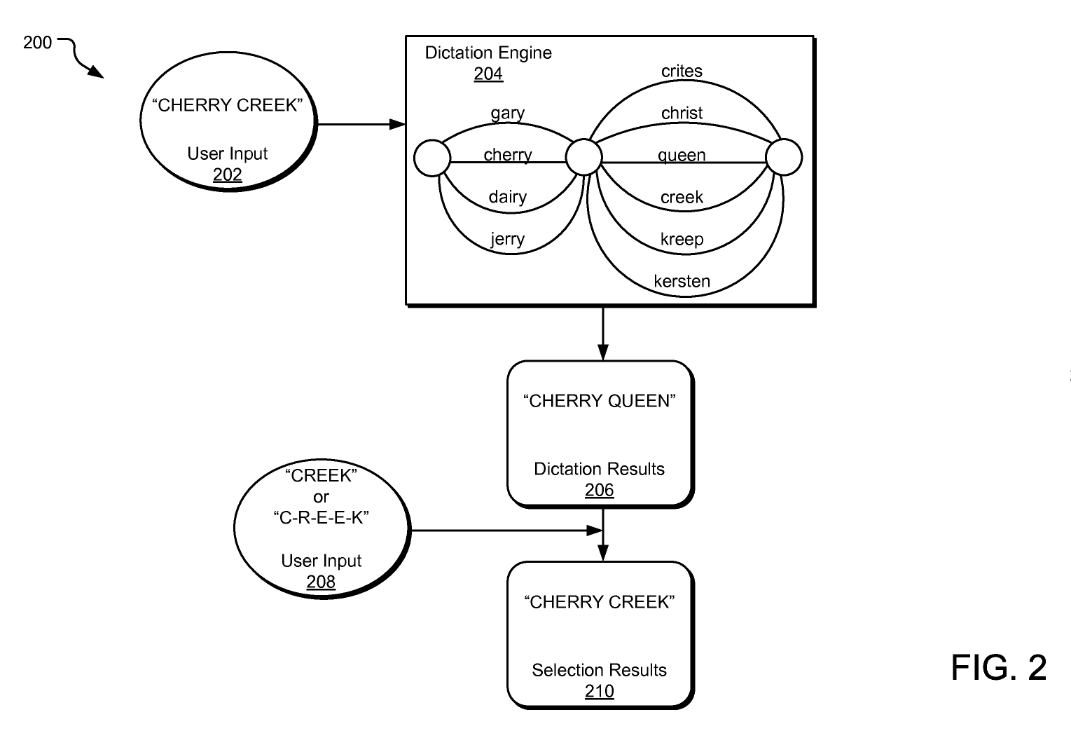

FIG. 2 illustrates an example implementation of a dictation system 200 using fuzzy pattern searching. The dictation system 200 includes a dictation engine 204, which receives user input 202. The user input 202 may be verbal input in the form of one or more sequences of characters, including words, phonemes, or phonetic fragments. Additionally, the user input 202 may be a sequence of characters in the form of handwriting. Further, the user input 202 may be a sequence of characters input via a virtual keyboard. The sequence of characters may include without limitation alphanumeric characters (e.g., letters A through Z and numbers 0 through 9), punctuation characters, control characters (e.g., a line-feed character), mathematical characters, sub-sequences of characters (e.g., words and terms), and other symbols. In one implementation, the sequences of characters may correspond to spelled instances of search terms, words, or other data entries. In the example implementation illustrated in FIG. 2, the user input 202 is the words “Cherry Creek.” The words may refer to a gamer tag, email, contact, social network, text, search term, application command, location, object, or other data entry.

The dictation engine 204 receives the user input 202 and performs pattern recognition by converting the user input 202 into query form (i.e. text) using, for example, an automated speech recognition (ASR) component or a handwriting translation component. In one implementation, the dictation engine 204 is customized to the speech or handwriting characteristics of one or more particular users.

The dictation engine 204 may use, for example, a statistical language model (SLM), such as an n-gram model, which permits flexibility in the form of user input. For example, the user may not pronounce the words or character sequences correctly. Additionally, the user may omit one or more characters or words. In one implementation, the SLM is trained based on a listing database that contains a fixed dataset including but not limited to a dictionary, social network information, text message(s), game information (e.g., gamer tags), application information, email(s), and contact list(s). The dictionary may include commonly misspelled character sequences, user added character sequences, commonly used character sequences or acronyms (e.g., OMG, LOL, BTW, TTYL, etc.), or other words or character sequences. Further, the listing database may include localized data including without limitation information corresponding to different regions, countries, or languages.

The dictations engine 204 returns one or more decoded speech recognition hypotheses, each including a sequence of character representations, which are the character(s) or word(s) that the dictation engine 204 recognizes as user input. The speech recognition hypotheses may be, for example, a set of n-best probabilistic recognitions of the input sequence of characters or words. The n-best probabilistic recognitions may be limited by fixing n according to a minimum threshold of probability or confidence, which is associated with each of the n-best probabilistic recognitions. The hypotheses are used to identify one or more probabilistic matches from the listing database. In the example implementation illustrated in FIG. 2, the dictation engine 204 returns four hypotheses for the first character sequence (i.e., “Cherry”) of the user input 202 and six hypotheses for the second character sequence (i.e., “Creek”) of the user input 202.

In one implementation, the dictation engine 204 selects one or more sequences of character representations from the one or more probabilistic matches and outputs dictation results 206. For example, the dictation engine 204 may select the probabilistic match with the highest confidence score. In the example implementation illustrated in FIG. 2, the dictation engine 204 outputs “Cherry Queen” as the dictation results 206.

In one implementation, a multimedia system presents the dictation results 206 to the user via a user interface. A correction pass may be performed to address any user and/or system errors in the dictation results 206. User errors include without limitation misspellings, omitted characters, added characters, or mispronunciations, and system errors include without limitation speech or handwriting recognition errors by the dictation engine 204. During the correction pass, the user provides user input 208. In one implementation, the user re-utters. rewrites, or retypes the misrecognized character sequence as the user input 208 (e.g., “Creek”). In another implementation, the user spells the misrecognized character sequence as the user input 208 (e.g., “C-R-E-E-K”). In still another implementation, a multimedia system presents one or more sequences of character representations to the user for selection, and the user selects the intended character sequence as the user input 208. For example, in the example implementation illustrated in FIG. 2, the user provides the misrecognized word “Creek” as the user input 208. Based on the user input 208, as multimedia system presents selection results 210. In the example implementation, the selection results 210 present the words “Cherry Creek,” which match the words provided by the user input 202.

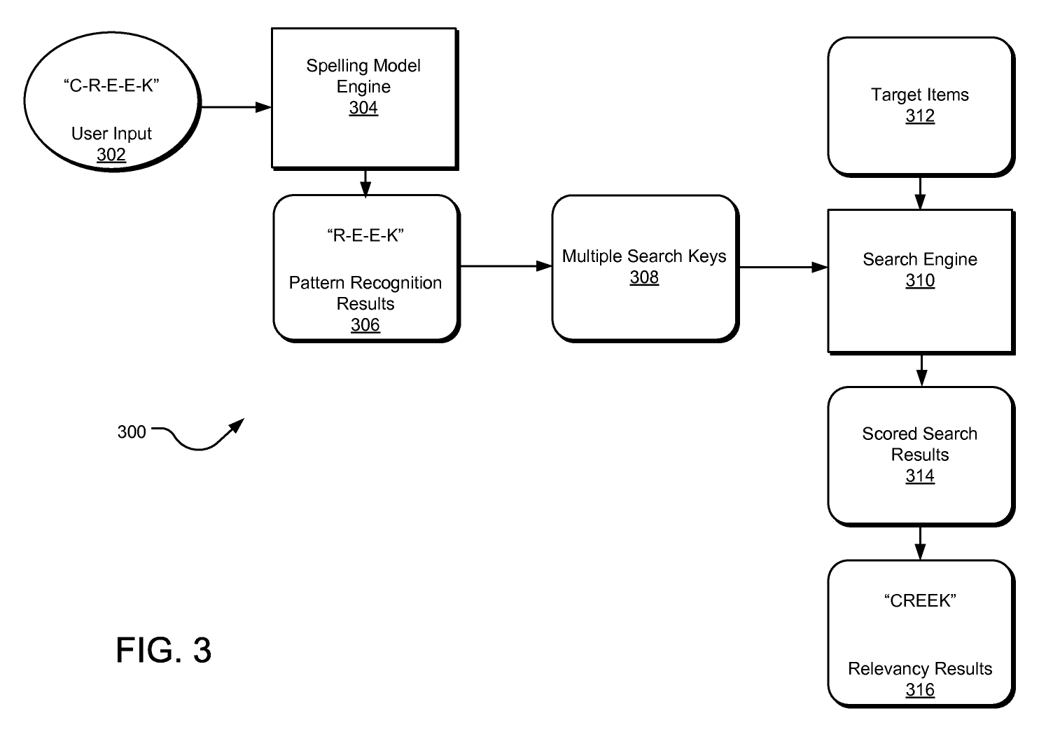

FIG. 3 illustrates an example implementation of a spelling system 300 using fuzzy pattern searching. The spelling system 300 includes a spelling model engine 304, which receives user input 302. The user input 302 may be verbal input in the form of one or more sequences of characters, including words, phonemes, or phonetic fragments. Additionally, the user input 302 may be a sequence of characters in the form of handwriting. Further, the user input 302 may be a sequence of characters input via a virtual keyboard. The sequence of characters may include without limitation alphanumeric characters (e.g., letters A through Z and numbers 0 through 9), punctuation characters, control characters (e.g., a line-feed character), mathematical characters, sub-sequences of characters (e.g., words and terms), and other symbols. In one implementation, the sequences of characters may correspond to spelled instances of search terms, words, or other data entries. In the example implementation illustrated in FIG. 3, the user input 302 is the spelled character sequence “C-R-E-E-K.” The character sequence may refer to a gamer tag, email, contact, social network, text, search term, application command, location, object, or other data entry.

The spelling model engine 304 receives the user input 302 and performs pattern recognition by converting the user input 302 into query form (i.e. text) using an automated speech recognition (ASR) component or a handwriting translation component. In one implementation, the spelling model engine 304 is customized to the speech or handwriting characteristics of one or more particular users.

The user input 302 may contain user errors and/or system errors. User errors include without limitation misspellings, omitted characters, added characters, or mispronunciations, and system errors include without limitation pattern recognition (e.g., speech or handwriting recognition) errors. For example, the user input 302 may contain omitted or added characters, misspelled character sequences, and/or the spelling model engine 304 may misrecognize the characters in the user input 302. Further, phonetically confusing letters (e.g., B, P, V, D, E, T, and C) may be merged into a reduced character set to improve overall pattern recognition accuracy.

The spelling model engine 304 outputs pattern recognition results 306, which include one or more decoded spelling recognition hypotheses. The pattern recognition results 306 are the character(s) the spelling model engine 304 recognizes as the user input 302. The pattern recognition hypotheses may be, for example, a set of n-best probabilistic recognitions of the user input 302. The n-best probabilistic recognitions may be limited by fixing n according to a minimum threshold of probability or confidence, which is associated with each of the n-best probabilistic recognitions. The hypotheses are used to identify one or more probabilistic matches from a listing database. From the probabilistic matches, a sequence of spelling character representations is recognized, which may have a possible ambiguity. The ambiguity may be based on errors including without limitation commonly misspelled character sequences, similarity in character or character sequence sound, character substitutions, character omissions, character additions, and alternative possible spellings. In the example implementation illustrated in FIG. 3, the pattern recognition results 306 includes a sequence of spelling character representations, “R-E-E-K,” with ambiguity. The ambiguity in the sequence of spelling character representations yields multiple search keys 308, each search key 308 including a character sequence.

To address the possible ambiguities, the multiple search keys 308 generated from the pattern recognition results 306 are input into a search engine 310, which performs a fuzzy pattern search to identify one or more probabilistic matches that exceed a relevancy threshold. In one implementation, the search engine 310 is dynamic such that the fuzzy pattern search is done in real-time as the user provides each character for the user input 302. In another implementation, the search engine 310 commences the fuzzy pattern search after the user provides all the characters for the user input 302.

The search engine 310 compares the multiple search keys 308 to a finite dataset of target items 312 contained in a search table, which is populated based on the listing database. Data for the listing database includes but is not limited to a dictionary, social network information, text message(s), game information, such as gamer tag(s), application information, email(s), and contact list(s). Further, the listing database may include localized data including without limitation information corresponding to different regions, countries, or languages. Each target item 312 includes a character sequence. In one implementation, each of the target items 312 includes a set of sub-sequences of characters. The set of sub-sequences of characters includes sub-sequences with multiple adjacent characters, including bigrams and trigrams. Each sub-sequence of characters begins at a different character position of the target item.

The multiple search keys 308 are generated from the pattern recognition results 306. The multiple search keys 308 may include multiple adjacent characters, including bigrams and trigrams. The search engine 310 may further remove one or more characters from the multiple search keys 308. In one implementation, non-alphanumeric characters such as punctuation characters or word boundaries are removed from the multiple search keys 308. In one implementation, phonetically confusing characters (e.g., B, P, V, D, E, T, and C) may be merged into a reduced search character set to account for possible pattern misrecognitions. The reduced search character set permits the pattern recognition to be performed without separating phonetically or graphically confusing character groups. In one implementation, a character from a reduced search character set is replaced with another character from the set, and the recognition of the character is relaxed to further include another character in the set. For example, generally the letter “B” and the letter “V” may not be reliably distinguished. To merge the confusing characters into a reduced search character set, “V's” are replaced with “B's” and the expected pronunciation of “V” is relaxed to include the pronunciation of “V” as well. Accordingly, the multiple search keys may be generated based on phoneme similarity, which represents a similarity in sound units associated with uttered characters. Alternatively, in the handwriting implementation, graphically confusing letters may be merged into a reduced search character set to account for possible pattern misrecognitions. The multiple search keys may be generated based on character or glyph similarity, which represents the similarity in appearance associated with written characters.

The search engine 310 performs the fuzzy pattern search by scoring each of the target items 312 based on the multiple search keys 308. In one implementation, each of the target items 312 is scored based on whether the target item matches at least one of the multiple search keys 308. The target items 312 are scored and ranked according to increasing relevance, which correlates to the resemblance of each of the target items 312 to the sequence of spelling character representations in the pattern recognition results 306. For example, the relevance value for a target item 312 is higher where a fixed-length search key 308 occurs in any position range in the search character sequence 312 or where a fixed-length search key 308 starts at the same initial character position as the target item 312. Additionally, contextual information that may be particular to a user is utilized to score and rank the target items 312.

Additionally, a ranking algorithm may be employed to further score and rank the target items 312 based on the prevalence of a search key 308 in the search table dataset of target items 312. For example, a term frequency-inverse document frequency (TF-IDF) ranking algorithm may be used, which increases the score of a target item 312 based on the frequency that a search key 308 occurs in the target item 312 and decreases the score based on the frequency that the search key 308 occurs in all target items 312 in the search table dataset.

The search engine 310 outputs scored search results 314, which includes the target items 312 and corresponding scores. Based on the scores of the target items 312 in the scored search results 314, one or more relevant items that satisfy a relevancy threshold are identified in relevancy results 316. In one implementation, one relevant item is identified and presented to the user. In another implementation, two or more relevant items are identified and presented to the user for selection. The user may select the intended character sequence from the presented relevant items, for example, through a user command including without limitation a verbal command, a gesture, pressing a button, and using a selector tool. In the example implementation illustrated in FIG. 3, “Creek” is identified in the relevancy results 316 as a relevant item.

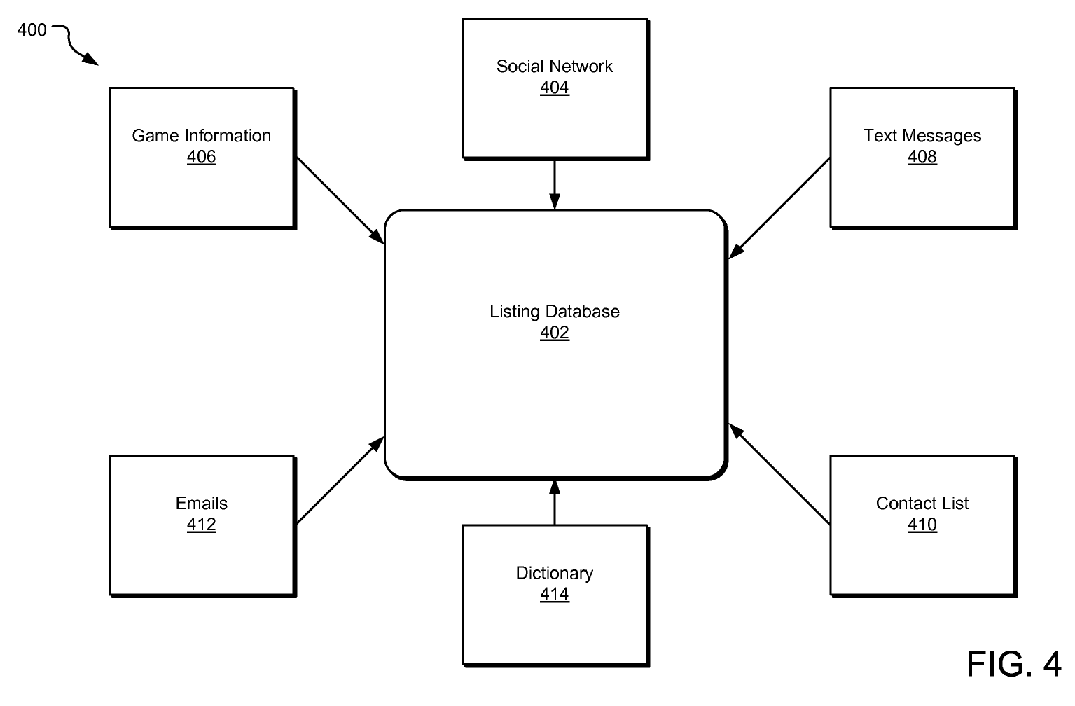

FIG. 4 illustrates an example implementation of six example listing database sources. In one implementation, listing database 402 includes information input from a social network 404, game information 406, text messages 408, a contact list 410, emails 412, and a dictionary 414. However, other sources such as application information and the internet are contemplated. Further, the listing database 402 may include localized data including without limitation information corresponding to different regions, countries, or languages. The localized data may be incorporated into one or more of the listing database 402 sources. In one implementation, the listing database 402 is customized to one or more particular users. For example, the data from the social network 404, game information 406, text messages 408, the contact list 410, and emails 412 may all contain the personal information of one or more particular users. Accordingly, the character sequences in the listing database 402 are customized to one or more particular users. In another implementation, the listing database 402 is dynamically updated as the data changes in one or more of the listing database 402 sources.

The listing database 402 is used to train a statistical language model (SLM) for speech recognition operations and to populate a search table with target items and corresponding context information. The target items may include without limitation alphanumeric characters (e.g., letters A through Z and numbers 0 through 9), punctuation characters, control characters (e.g., a line-feed character), mathematical characters, sub-sequences of characters (e.g., words and terms), and other symbols. In one implementation, the target items may correspond to spelled instances of search terms, words, or other data entries. In another implementation, the target items are based on information customized to a particular user.

Each target item includes a set of character sequences. In one implementation, the set of character sequences includes sub-sequences with multiple adjacent characters, including bigrams and trigrams. Each sub-sequence of characters begins at a different character position of the character sequence. Each target item is indexed according to the set of character sequences and the corresponding context information.

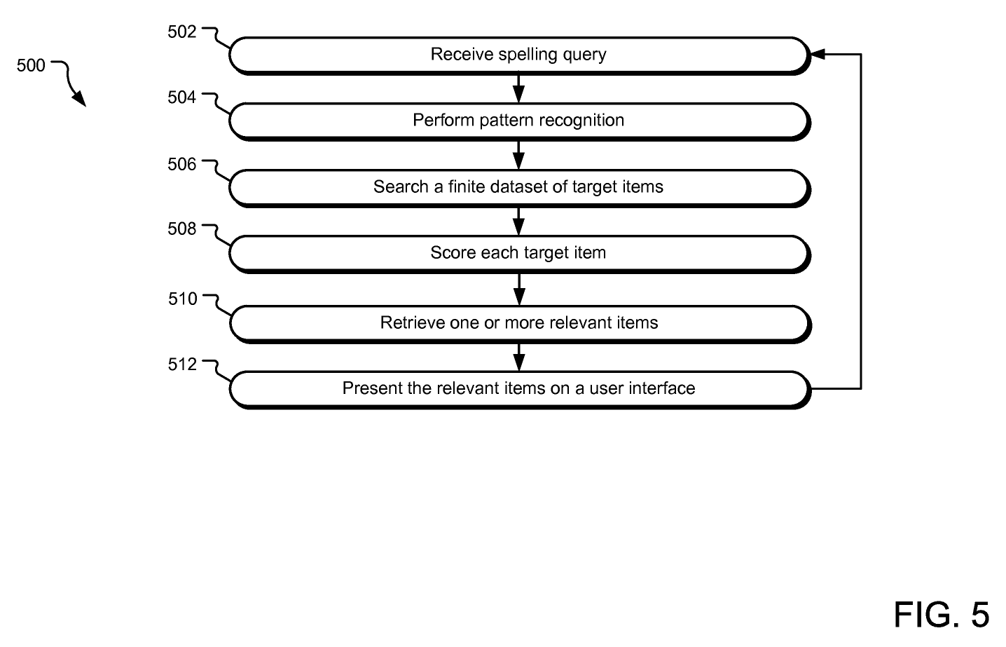

FIG. 5 illustrates example operations 500 for spelling using a fuzzy pattern search. In one implementation, the operations 500 are executed by software. However, other implementations are contemplated.

During a receiving operation 502, a multimedia system receives a spelling query. In one implementation, a user provides input to the multimedia system via a user interface. The user input may be verbal input in the form of one or more sequences of characters, including words, phonemes, or phonetic fragments. Additionally, the user input may be a sequence of characters in the form of handwriting. Further, the user input may be a sequence of characters input via a virtual keyboard. The sequence of characters may include without limitation alphanumeric characters (e.g., letters A through Z and numbers 0 through 9), punctuation characters, control characters (e.g., a line-feed character), mathematical characters, sub-sequences of characters (e.g., words and terms), and other symbols. In one implementation, the sequences of characters may correspond to spelled instances of search terms, words, or other data entries.

During the receiving operation 502, the multimedia system receives the user input and converts the user input into a spelling query (i.e. text) using, for example, an automated speech recognition (ASR) component or a handwriting translation component. The spelling query may contain user errors and/or system errors. User errors include without limitation misspellings, omitted characters, added characters, or mispronunciations, and system errors include without limitation speech or handwriting recognition errors.

A recognition operation 504 performs pattern recognition of the spelling query received during the receiving operation 502. The recognition operation 504 returns one or more decoded spelling recognition hypotheses, which are the character(s) the multimedia system recognizes as the spelling input sequence of characters input by the user. The spelling recognition hypotheses may be, for example, a set of n-best probabilistic recognitions of the spelling input sequence of characters. The n-best probabilistic recognitions may be limited by fixing n according to a minimum threshold of probability or confidence, which is associated with each of the n-best probabilistic recognitions. The hypotheses are used to identify one or more probabilistic matches from a listing database. From the probabilistic matches, a sequence of spelling character representations is recognized. The sequence of spelling character representations may have a possible ambiguity. The ambiguity may be based on user and/or system errors including without limitation commonly misspelled character sequences, similarity in character sound, character substitutions, character omissions, character additions, alternative possible spellings. The ambiguity in the sequence of spelling character representations yields multiple search keys, each search key including a character sequence.

A searching operation 506 compares the multiple search keys to a finite dataset of target items contained in a search table, which is populated based on the listing database. Data for the listing database includes but is not limited to a dictionary, social network information, text message(s), game information, such as gamer tag(s), application information, email(s), and contact list(s). Further, the listing database may include localized data including without limitation information corresponding to different regions, countries, or languages. Each target item includes a character sequence. In one implementation, each target item includes a set of sub-sequences of characters. The set of sub-sequences of characters includes sub-sequences with multiple adjacent characters, including bigrams and trigrams. Each sub-sequence of characters begins at a different character position of the target item.

The multiple search keys are generated from the results of the recognition operation 504. The search keys may include multiple adjacent characters, including bigrams and trigrams. One or more characters may be removed from the multiple search keys. In one implementation, non-alphanumeric characters such as punctuation characters or word boundaries are removed from the multiple search keys. Further, in one implementation, phonetically confusing letters (e.g., B, P, V, D, E, T, and C) may be merged into a reduced search character set to account for possible pattern misrecognitions during the searching operation 506. The reduced search character set permits the pattern recognition to be performed without separating phonetically or graphically confusing character groups. In one implementation, a character from a reduced search character set is replaced with another character from the set, and the recognition of the character is relaxed to further include another character in the set. For example, generally the letter “B” and the letter “V” may not be reliably distinguished. To merge the confusing characters into a reduced search character set, “V's” are replaced with “B's” and the expected pronunciation of “V” is relaxed to include the pronunciation of “V” as well. Accordingly, the multiple search keys may be generated based on phoneme similarity.

A scoring operation 508 scores and ranks each target item based on the multiple search keys. In one implementation, each target item is scored based on whether the target item matches at least one the multiple search keys. The scoring operation 508 scores and ranks target items according to increasing relevance, which correlates to the resemblance of each target item to the sequence of spelling character representations. Additionally, the scoring operation 508 may utilize contextual information that may be particular to the user to rank the target items. In one implementation, the searching operation 506 and the scoring operation 508 are performed concurrently such that the target items are scored and ranked as the multiple search keys are compared to each target item.

Based on the scores of the target items, one or more relevant items that exceed a relevancy threshold are retrieved in the retrieving operation 510. In one implementation, during a presenting operation 512, one relevant item is presented to the user via a user interface. In another implementation, the presenting operation 512 presents two or more relevant items to the user for selection. The user may select the intended character sequence from the presented relevant items, for example, through a user command including without limitation a verbal command, a gesture, pressing a button, and using a selector tool.

In one implementation, the operations 500 are dynamic such that the operations 500 are done in real-time as the user provides each character during the receiving operation 502, and the operations 500 iterate for each character. In another implementation, the operations 500 commence after the user provides all the characters in the user input during the receiving operation 502.

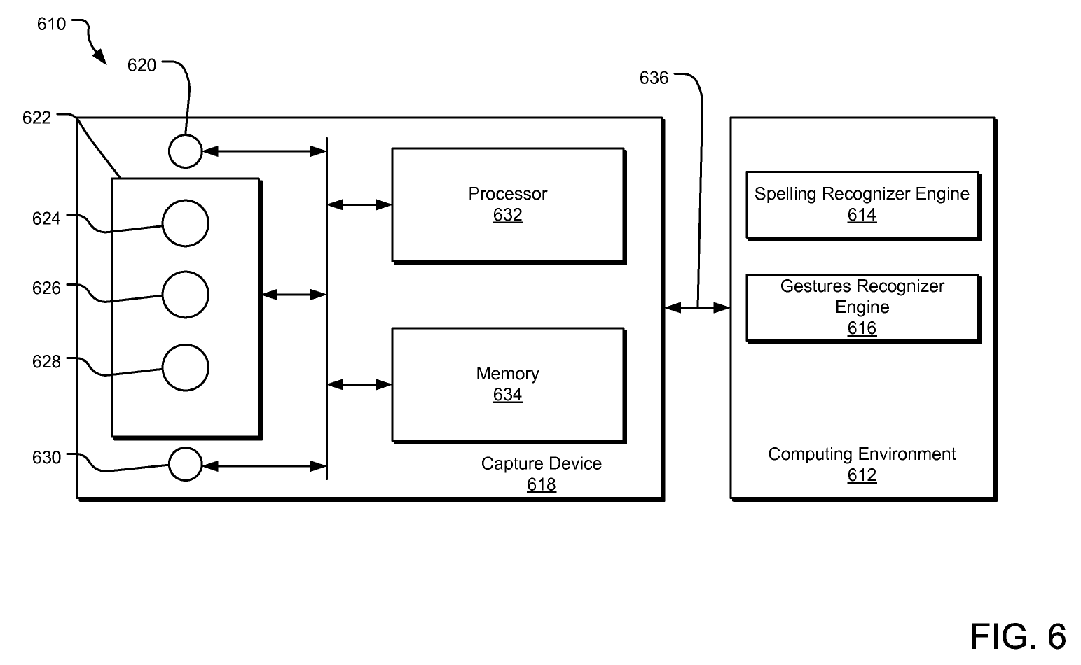

FIG. 6 illustrates an example implementation of a capture device 618 that may be used in a spelling recognition, search, and analysis system 610. According to one example implementation, the capture device 618 is configured to capture sound with language information including one or more spoken words or character sequences. In another example implementation, the capture device 618 is configured to capture handwriting samples with language information including one or more handwritten words or character sequences.

The capture device 618 may include a microphone 630, which includes a transducer or sensor that receives and converts sound into an electrical signal. The microphone 630 is used to reduce feedback between the capture device 618 and a computing environment 612 in the language recognition, search, and analysis system 610. The microphone 630 is used to receive audio signals provided by a user to control applications, such as game occasions, non--game applications, etc. or enter data that may be executed in the computing environment 612.

In one implementation, the capture device 618 may be in operative communication with a touch-sensitive display, scanner, or other device for capturing handwriting input (not shown) via a handwriting input component 620. The touch input component 620 is used to receive handwritten input provided by a user and convert the handwritten input into an electrical signal to control applications or enter data that may be executed in the computing environment 612. In another implementation, the capture device 618 may employ an image camera component 622 to capture handwriting samples.

The capture device 618 may further configured to capture video with depth information including a depth image that may include depth values via any suitable technique including, for example, time-of-flight, structured light, stereo image, or the like. According to one implementation, the capture device 618 organizes the calculated depth information into “Z layers,” or layers that are perpendicular to a Z-axis extending from the depth camera along its line of sight, although other implementations may be employed.

According to an example implementation, the image camera component 622 includes a depth camera that captures the depth image of a scene. An example depth image includes a two-dimensional (2-D) pixel area of the captured scene, where each pixel in the 2-D pixel area may represent a distance of an object in the captured scene from the camera. According to another example implementation, the capture device 618 includes two or more physically separate cameras that view a scene from different angles to obtain visual stereo data that may be resolved to generate depth information.

The image camera component 622 includes an IR light component 624, a three-dimensional (3-D) camera 626, and an RGB camera 628. For example, in time-of-flight analysis, the IR light component 624 of the capture device 618 emits an infrared light onto the scene and then uses sensors (not shown) to detect the backscattered light from the surface of one or more targets and objects in the scene using, for example, the 3-D camera 626 and/or the RGB camera 628. In some implementations, pulsed infrared light may be used such that the time between an outgoing light pulse and a corresponding incoming light pulse may be measured and used to determine a physical distance from the capture device 618 to particular locations on the targets or objects in the scene. Additionally, in other example implementations, the phase of the outgoing light wave may be compared to the phase of the incoming light wave to determine a phase shift. The phase shift may then be used to determine a physical distance from the capture device 618 to particular locations on the targets or objects in the scene.

According to another example implementation, time-of-flight analysis may be used to directly determine a physical distance from the capture device 618 to particular locations on the targets and objects in a scene by analyzing the intensity of the reflected light beam over time via various techniques including, for example, shuttered light pulse imaging.

In another example implementation, the capture device 618 uses a structured light to capture depth information. In such an analysis, patterned light (e.g., light projected as a known pattern, such as a grid pattern or a stripe pattern) is projected onto the scene via, for example, the IR light component 624. Upon striking the surface of one or more targets or objects in the scene, the pattern may become deformed in response. Such a deformation of the pattern is then captured by, for example, the 3-D camera 626 and or the RGB camera 628 and analyzed to determine a physical distance from the capture device to particular locations on the targets or objects in the scene.

In an example implementation, the capture device 618 further includes a processor 632 in operative communication with the microphone 630, the touch input component 620, the image camera component 622. The processor 632 may include a standardized processor, a specialized processor, a microprocessor, etc. that executes processor-readable instructions including, without limitation, instructions for receiving language information, such as a word or spelling query, or for performing speech and/or handwriting recognition. The processor 632 may further execute processor-readable instructions for gesture recognition including, without limitation, instructions for receiving the depth image, determining whether a suitable target may be included in the depth image or for converting the suitable target into a skeletal representation or model of the target. However, the processor 632 may include any other suitable instructions.

The capture device 618 may further include a memory component 634 that stores instructions for execution by the processor 632, sounds and/or a series of sounds and handwriting data. The memory component may further store any other suitable information including but not limited to images and/or frames of images captured by the 3-D camera 626 or RGB camera 628. According to an example implementation, the memory component 634 may include random access memory (RAM), read-only memory (ROM), cache memory, Flash memory, a hard disk, or any other suitable storage component. In one implementation, the memory component 634 may be a separate component in communication with the processor 632 and the microphone 630, the touch input component 620, and/or the image capture component 622. According to another implementation, the memory component 634 may be integrated into the processor 632, the microphone 630, the touch input component 620, and/or the image capture component 622.

The capture device 618 provides the language information, sounds, and handwriting input captured by the microphone 630 and/or the touch input component 620 to the computing environment 612 via a communication link 636. The computing environment the uses the language information, and captured sounds and/or handwriting input to, for example, recognize user words or character sequences and in response control an application, such as a game or word processor, or retrieve search results from a database. The computing environment 612 includes a language recognizer engine 614. In one implementation, the language recognizer engine 614 includes a finite database of character sequences and corresponding context information. The language information captured by the microphone 630 and/or the touch input component 620 may be compared to the database of character sequences in the language recognizer engine 614 to identify when a user has spoken and/or handwritten one or more words or character sequences. These words or character sequences may be associated with various controls of an application. Thus, the computing environment 612 uses the language recognizer engine 614 to interpret language information and to control an application based on the language information.

Additionally, the computing environment 612 may further include a gestures recognizer engine 616. The gestures recognizer engine 616 includes a collection of gesture filters, each comprising information concerning a gesture that may be performed by the skeletal model (as the user moves). The data captured by the cameras 626, 628, and the capture device 618 in the form of the skeletal model and movements associated with it may be compared to the gesture filters and the gestures recognizer engine 616 to identify when a user (as represented by the skeletal model) has performed one or more gestures. Accordingly, the capture device 618 provides the depth information and images captured by, for example, the 3-D camera 626 and or the RGB camera 628, and a skeletal model that is generated by the capture device 618 to the computing environment 612 via the communication link 636. The computing environment 612 then uses the skeletal model, depth information, and captured images to, for example, recognize user gestures and in response control an application or select an intended character sequence from one or more relevant items presented to the user.

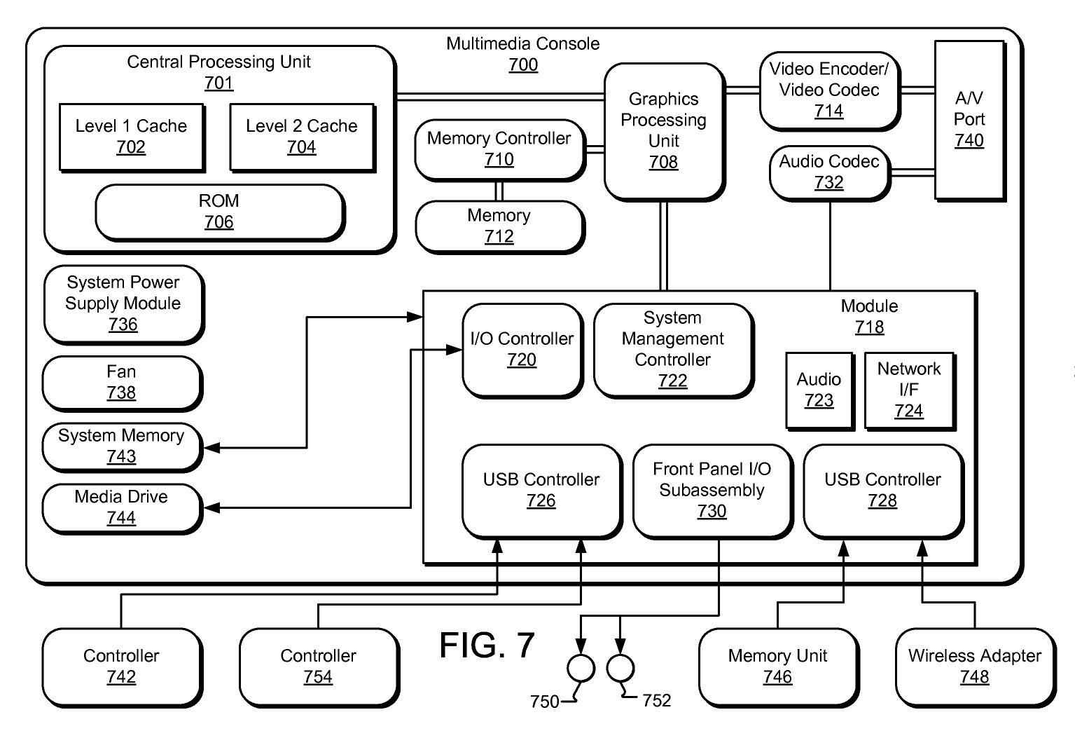

FIG. 7 illustrates an example implementation of a computing environment that may be used to interpret one or more character sequences in a spelling recognition, search, and analysis system. The computing environment may be implemented as a multimedia console 700. The multimedia console 700 has a central processing unit (CPU) 701 having a level 1 cache 702, a level 2 cache 704, and a flash ROM (Read Only Memory) 706. The level 1 cache 702 and the level 2 cache 704 temporarily store data, and hence reduce the number of memory access cycles, thereby improving processing speed and throughput. The CPU 701 may be provided having more than one core, and thus, additional level 1 and level 2 caches. The flash ROM 706 may store executable code that is loaded during an initial phase of the boot process when the multimedia console 700 is powered on.

A graphics processing unit (GPU) 708 and a video encoder/video codec (coder/decoder) 714 form a video processing pipe line for high-speed and high-resolution graphics processing. Data is carried from the GPU 708 to the video encoder/video codec 714 via a bus. The video processing pipeline outputs data to an A/V (audio/video) port 740 transmission to a television or other display. The memory controller 710 is connected to the GPU 708 to facilitate processor access to various types of memory 712, such as, but not limited to, a RAM (Random Access Memory).

The multimedia console 700 includes an I/O controller 720, a system management controller 722, an audio processing unit 723, a network interface controller 724, a first USB host controller 726, a second USB controller 728, and a front panel I/O subassembly 730 that are implemented in a module 718. The USB controllers 726 and 728 serve as hosts for peripheral controllers 742 and 754, a wireless adapter 748, and an external memory unit 746 (e.g., flash memory, external CD/DVD drive, removable storage media, etc.). The network interface controller 724 and/or wireless adapter 748 provide access to a network (e.g., the Internet, a home network, etc.) and may be any of a wide variety of various wired or wireless adapter components, including an Ethernet card, a modem, a Bluetooth module, a cable modem, and the like.

System memory 743 is configured to store application data that is loaded during the boot process. In an example implementation, a spelling recognizer engine, a search engine, and other engines and services may be embodied by instructions stored in system memory 743 and processed by the CPU 701. Search table databases, captured speech and/or spelling, handwriting data, spelling models, spelling information, pattern recognition results (e.g., speech recognition results and/or handwriting recognition results), images, gesture recognition results, and other data may be stored in system memory 743.

Application data may be accessed via a media drive 744 for execution, playback, etc. by the multimedia console 700. The media drive 744 may include a CD/DVD drive, hard drive, or other removable media drive, etc. and may be internal or external to the multimedia console 700. The media drive 744 is connected to the I/O controller 720 via a bus, such as a serial ATA bus or other high-speed connection (e.g., IEEE 1394).

The system management controller 722 provides a variety of service functions related to assuring availability of the multimedia console 700. The audio processing unit 723 and an audio codec 732 form a corresponding audio processing pipeline with high fidelity and stereo processing. Audio data is carried between the audio processing unit 723 and the audio codec 732 via a communication link. The audio processing pipeline outputs data to the A/V port 740 for reproduction by an external audio player or device having audio capabilities.

The front panel I/O sub assembly 730 supports the functionality of a power button 750 and an eject button 752, as well as any LEDs (light emitting diodes) or other indicators exposed on the outer surface of the multimedia console 700. A system power supply module 736 provides power to the components of the multimedia console 700, and a fan 738 cools the circuitry within the multimedia console 700.

The CPU 701, GPU 708, the memory controller 710, and various other components within the multimedia console 700 are interconnected via one or more buses, including serial and parallel buses, a memory bus, a peripheral bus, and/or a processor or local bus using any of a variety of bus architectures. By way of example, such bus architectures may include without limitation a Peripheral Component Interconnect (PCI) bus, a PCI-Express bus, etc.

When the multimedia console 700 is powered on, application data may be loaded from the system memory 743 into memory 712 and/or caches 702, and 704 and executed on the CPU 701. The application may present a graphical user interface that provides a consistent user interface when navigating to different media types available on the multimedia console 700. In operation, applications and/or other media contained within the media drive 744 may be launched and/or played from the media drive 744 to provide additional functionalities to the multimedia console 700.

The multimedia console 700 may be operated as a stand-alone system by simply connecting the system to a television or other display. In the stand-alone mode, the multimedia console 700 allows one or more users to interact with the system, watch movies, or listen to music. However, with the integration of broadband connectivity made available through the network interface controller 724 or the wireless adapter 748, the multimedia console 700 may further be operated as a participant in a larger network community.

When the multimedia console 700 is powered on, a defined amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because the resources are reserved at system boot time, the reserve resources are not available for an application's use. The memory reservation may be large enough to contain the launch kernel, concurrent system applications, and drivers. The CPU reservations may be constant, such that if the reserve CPU usage is not returned by the system applications, an idle thread will consume any unused cycles.

With regard to the GPU reservation, lightweight messages generated by the system applications (e.g., pop-ups) are displayed by using a GPU interrupt to schedule code to render popup into an overlay. The amount of memory necessary for an overlay depends on the overlay area size, and the overlay may scale with screen resolution. Where a full user interface is used by the concurrent system application, the resolution may be independent of application resolution. A scalar may be used to set this resolution, such that the need to change frequency and cause ATV re-sync is eliminated.

After the multimedia console 700 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications may be scheduled to run on the CPU 701 at predetermined times and intervals to provide a consistent system resource view to the application. The scheduling minimizes cache disruption for the game application running on the multimedia console 700.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 742 and 754) are shared by gaming applications and system applications. In an implementation, the input devices are not reserved resources but are to be switched between system applications and gaming applications such that each will have a focus of the device. An application manager preferably controls the switching of input stream, and a driver maintains state information regarding focus switches. Microphones, cameras, and other capture devices may define additional input devices for the multimedia console 700.

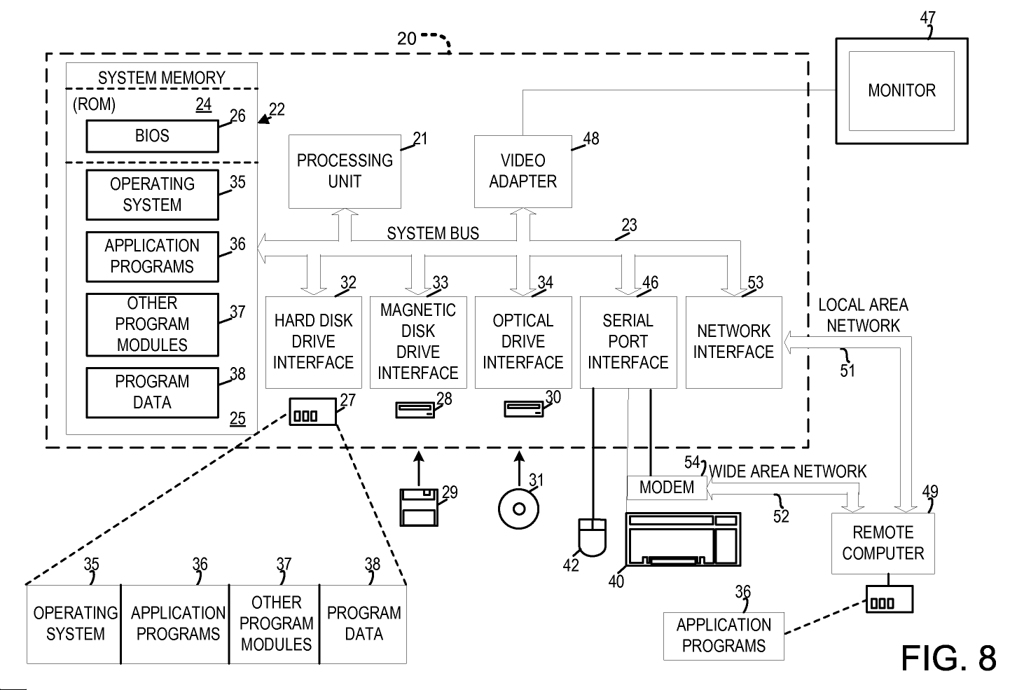

FIG. 8 illustrates an example system that may be useful in implementing the described technology. The example hardware and operating environment of FIG. 8 for implementing the described technology includes a computing device, such as general purpose computing device in the form of a gaming console, multimedia console, or computer 20, a mobile telephone, a personal data assistant (PDA), a set top box, or other type of computing device. In the implementation of FIG. 8, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program engines and other data for the computer 20.It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, magnetic disk 29, optical disk 31, ROM 24, or RAM 25, including an operating system 35, one or more application programs 36, other program engines 37, and program data 38. A user may enter commands and information into the personal computer 20 through input devices such as a keyboard 40 and pointing device 42.Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 8. The logical connections depicted in FIG. 8 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, a spelling recognizer engine, a search engine, and other engines and services may be embodied by instructions stored in memory 22 and/or storage devices 29 or 31 and processed by the processing unit 21. Search table databases, captured speech and/or spelling, handwriting data, spelling models, spelling information, pattern recognition results (e.g., spelling recognition results and/or handwriting recognition results), images, gesture recognition results, and other data may be stored in memory 22 and/or storage devices 29 or 31 as persistent datastores.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
recognizing a sequence of spelling character representations, the sequence of spelling character representations having a possible ambiguity yielding multiple search keys;
scoring one or more target items from a finite dataset of target items based on the multiple search keys, each target item including a character sequence; and
identifying one or more relevant items from the scored target items, each relevant item satisfying a relevance threshold.

2. The method of claim 1 wherein the multiple search keys are generated based on phoneme similarity.

3. The method of claim 1 wherein the target items are based on information customized to a particular user.

4. The method of claim 1 wherein the possible ambiguity is based on a user error.

5. The method of claim 1 wherein one or more characters in at least one of the multiple search keys are merged into a reduced search character set.

6. The method of claim 1 wherein the possible ambiguity is based on a system error.

7. The method of claim 1 wherein the sequence of spelling character representations is recognized from a spoken spelling sequence.

8. One or more tangible computer-readable storage media storing computer-executable instructions for performing a computer process on a computing system, the computer process comprising:
recognizing a sequence of spelling character representations, the sequence of spelling character representations having a possible ambiguity yielding multiple search keys;
scoring one or more target items from a finite dataset of target items based on the multiple search keys; and
identifying one or more relevant items from the scored target items, each relevant item satisfying a relevance threshold.

9. The one or more tangible computer-readable storage media of claim 8 wherein the multiple search keys are generated based on phoneme similarity.

10. The one or more tangible computer-readable storage media of claim 8 wherein the target items are based on information customized to a particular user.

11. The one or more tangible computer-readable storage media of claim 8 wherein the possible ambiguity is based on a user error.

12. The one or more tangible computer-readable storage media of claim 8 wherein one or more characters in at least one of the multiple search keys are merged into a reduced search character set.

13. The one or more tangible computer-readable storage media of claim 8 wherein the possible ambiguity is based on a system error.

14. The one or more tangible computer-readable storage media of claim 8 wherein the sequence of spelling character representations is recognized from a spoken spelling sequence.

15. A spelling search system comprising:
a user interface configured to receive a spelling query;
a spelling recognizer engine configured to recognize a sequence of character representations from the spelling query, the sequence having a possible ambiguity yielding multiple search keys; and
a search engine configured to score one or more target items from a finite dataset of target items based on the multiple search keys, the scored target items being used to identify one or more relevant items that satisfy relevancy threshold.

16. The spelling search system of claim 15 wherein the possible ambiguity is based on a system error.

17. The spelling search system of claim 15 wherein the multiple search keys are generated based on phoneme similarity.

18. The spelling search system of claim 15 wherein the target items are based on information customized to a particular user.

19. The spelling search system of claim 15 wherein the possible ambiguity is based on a user error.

20. The spelling search system of claim 15 wherein the spelling query is based on a spoken character sequence.
